(19) United States
(12) Patent Application Publication
(10) Pub. No.: US 2017/0246683 A1
(43) Pub. Date: Aug. 31, 2017

(54) Method for Layer-By-Layer Removal of Defects During Additive Manufacturing

(71) Applicant: Moog Inc., East Aurora, NY (US)

(72) Inventors: Jason C. Jones, Buffalo, NY (US); Ian L. Brooks, Gloucester (GB)

(21) Appl. No.: 15/508,226

(22) PCT Filed: Aug. 18, 2015
(86) PCT No.: PCT/US15/45658

§ 371 Date: Mar. 2, 2017

Related U.S. Application Data
(60) Provisional application No. 62/052,630, filed on Sep. 19, 2014.

(51) Int. Cl. B22F 3/105; B33Y 10/00; B29C 67/00

(52) U.S. Cl. CPC B22F 3/1055; B29C 67/0077; B33Y 10/00

(57) ABSTRACT

Surface and sub-surface defects are removed during additive manufacturing. After a layer of an object is formed in a powder bed, a portion of the layer is removed while the object is in the powder bed to remove surface and or sub-surface defects. The removal step may be performed on a layer-by-layer basis. A directed energy beam or tool may be used to remove a shallow object-powder interface portion of the layer, or a deeper skin portion of the layer. In this way, the completed object may be removed from the powder bed substantially free of surface roughness and sub-surface defects.

### CROSS-REFERENCE TO RELATED APPLICATIONS

This application claims priority to the provisional patent application entitled “Method for Layer-by-Layer Removal of Defects During Additive Manufacturing,” filed Sep. 19, 2014 and assigned U.S. App. No. 62/052,630, the disclosure of which is hereby incorporated by reference.

### FIELD OF THE DISCLOSURE

This disclosure relates to additive manufacturing and, more particularly, to powder bed additive manufacturing.

### BACKGROUND OF THE DISCLOSURE

Additive manufacturing can be used to produce complex, lightweight three-dimensional objects. For example, an aerospace servovalve is estimated to be 30% to 50% lighter than other methods when fabricated by additive manufacturing. Additive manufacturing is growing in popularity due to these benefits.

Additive manufacturing may produce a three-dimensional object by using an energy source, such as a laser beam or an electron beam, to fuse a level powder surface into a thin layer of solid material. A further level of powder is applied after a layer is formed, some of which is then fused to the previously-formed layer to form another layer. This process is repeated until a three-dimensional object is built up layer-by-layer. This process is referred to by various other names, including powder bed fusion and laser selective melting. The process can be applied to metals, plastics, or other materials capable of being fused together.

It is recognized that defects may be formed in each layer during additive manufacturing. These defects include both surface roughness (surface defects), and internal pores or voids (sub-surface defects). These defects can lead to problems in the finished object. The surface roughness of parts in the “as printed” condition is prone to shedding or, in other words, can generate foreign object debris (FOD). The aforementioned defects may also cause stress raisers and may contribute to poor fatigue performance.

Surface roughness may occur at the interface between the fused and unfused powder particles (the “object-powder interface”). Surface roughness occurs when powder particles that are partially inside and partially outside the desired geometry of a layer of an object are retained in the layer after fusing. Surface roughness also occurs when powder particles intended to be fused into the object layer do not properly fuse with and attach to the object layer. Thus, surface roughness exists where particles project beyond the desired geometry of the layer, and where surface particles are missing from the desired surface geometry.

Sub-surface defects (e.g. pores or voids), when present, typically occur in the fused layer within approximately 100-150 μm of the object-powder interface. The exact mechanism that causes formation of pores or voids can vary. For example, some powder particles may be hollow or porous prior to fusing. An incorrect laser parameter or resolution of the laser beam may cause pores or voids to form. Pores or voids may also form due to improper fusion of the layer just inside the object-powder interface.

Heretofore, defects have been removed from an object once the additive manufacturing steps have been completed and all layers have been fused. For example, aggressive cleaning or surface treatment after the object is completed may be used to take off an outer portion of the object. Aggressive cleaning and surface treatment of the object are time-consuming, costly, involve hazardous materials, and increase the number of required process steps. These also require that objects be designed with excess material on the desired geometry to compensate for the loss, which can be complicated because this loss can vary. Cleaning and surface treatment may not be able to sufficiently remove sub-surface defects. The more complex the geometry of the object, for example the more internal passageways the object has, the less likely it is that all defects can be removed using the mentioned methods.

Therefore, what is needed is an improved method of additive manufacturing and, more particularly, a method of removing defects associated with additive manufacturing.

### BRIEF SUMMARY OF THE DISCLOSURE

The disclosure provides a method of additive manufacturing whereby surface roughness and sub-surface defects may be substantially eliminated from an object without the need for subsequent processing steps. The method generally comprises the steps of forming a layer of an object in a powder bed by scanning a directed energy beam over a predetermined target area of the powder bed to fuse powder in the predetermined area, wherein the layer defines an object-powder interface at a boundary where fused powder of the layer meets unfused powder of the powder bed, and removing a portion of the layer while the object is in the powder bed. Manufacturing may continue by applying a level of powder to the powder bed, forming another layer, and removing a portion of that layer. In this way, the object is built layer-by-layer and may be removed from the powder bed substantially free of surface roughness and sub-surface defects.

In one embodiment, the removed portion of the layer includes only the object-powder interface. In another embodiment, the removed portion of the layer includes a peripheral skin portion of the layer deeper than the object-powder interface. Removal of the layer portion may be performed using a directed energy beam or tool to ablate material along the object-powder interface, or along a path offset slightly inward from the object-powder interface.

### DESCRIPTION OF THE DRAWINGS

For a fuller understanding of the nature and objects of the disclosure, reference should be made to the following detailed description taken in conjunction with the accompanying drawings, in which:

FIG. 1 is a perspective view showing an additive manufacturing method in accordance with an embodiment of the present disclosure;

FIG. 2 is a sectional view of a powder bed shown in FIG. 1;

FIG. 3 is a sectional view similar to that of FIG. 2, illustrating an additive manufacturing method in accordance with an alternative embodiment of the present disclosure; and

FIG. 4 is a flowchart illustrating step sequence of an additive manufacturing method in accordance with an embodiment of the present disclosure.

### DETAILED DESCRIPTION OF THE DISCLOSURE

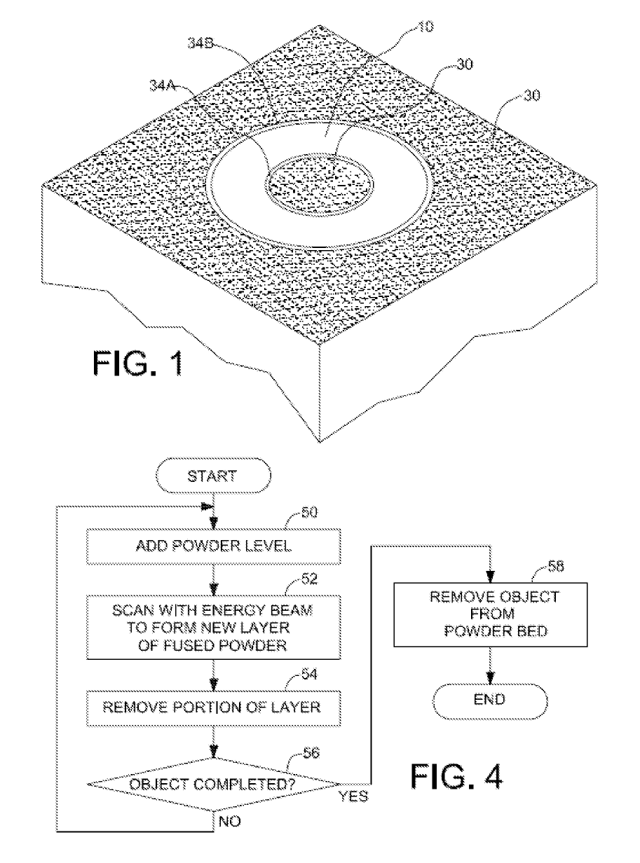

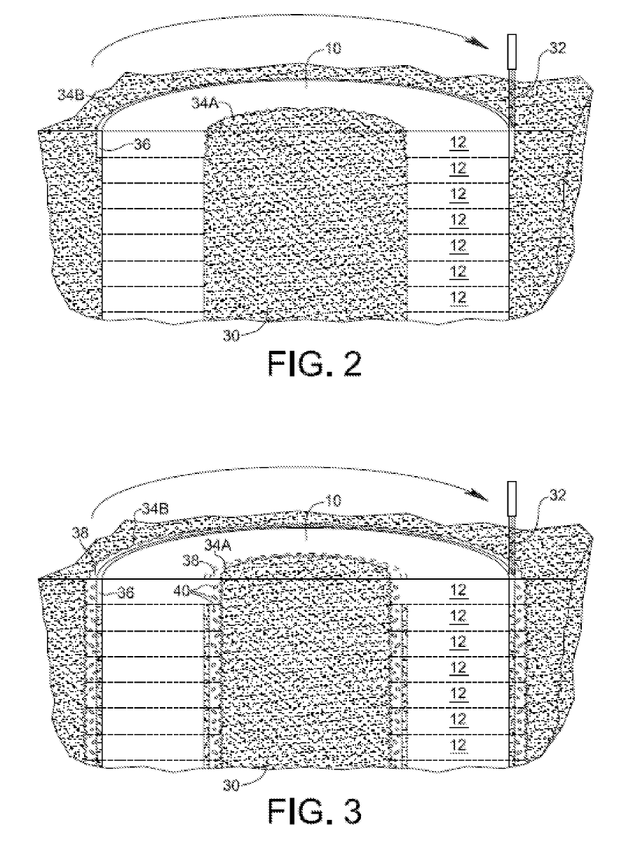

FIGS. 1 and 2 show the formation of an object 10 by an additive manufacturing method in accordance with a first embodiment of the present disclosure. For sake of example, object 10 is a cylindrical tube having an outer diameter and inner diameter that remain constant over the tube's entire axial length. The particular shape of object 10 may vary, and the object illustrated in FIGS. 1 and 2 is merely exemplary. Object 10 is formed by additive manufacturing and thus is situated in a powder bed 30 composed of powder particles of a chosen material. The powder particles may be generally spherical, ovoid, or irregular in shape. By way of non-limiting example, the diameter or largest dimension of the individual particles may be on the order of approximately 15 μm to 45 μm. Object 10 is formed layer-by-layer. Each object layer 12 is formed by scanning a directed energy beam, such as a laser beam or an electron beam, over a predetermined area of powder bed 30 to fuse powder in the predetermined area. The formed layer 12 defines at least one object-powder interface at a boundary where fused powder of layer 12 meets unfused powder of powder bed 30. In the present example, the predetermined area is ring-shaped, such that an inner object-powder interface 34A and an outer object-powder interface 34B are defined. The height of each layer 12, exaggerated out of scale in FIG. 2 for sake of illustration, may be on the order of approximately 30 μm, though other dimensions are possible.

In a method according to a first embodiment of the present disclosure, surface roughness at object-powder interfaces 34A and 34B is minimized by removing a portion of layer 12 while object 10 is in powder bed 30. In the first embodiment, the removed portion of layer 12 includes only the object-powder interfaces 34A and 34B. The step of removing a portion of layer 12 may be performed using a directed energy beam 32. Directed energy beam 32 may be the same beam (i.e. a beam from the same source) as that used to form the layer. Alternatively, directed energy beam 32 may be a second directed energy beam, for example a laser beam or an electron beam, that is different (i.e. that is from a different source) than the directed energy beam used to form the layer. As a further alternative, the removal step may be performed using a high-speed micro-machining tool, for example a micro-precision grinding wheel.

The directed energy beam for fusing layer 12, and the energy beam 32 or tool for removing the portion of layer 12, may be motion-controlled by a programmable motion control system. In the first embodiment, the directed energy beam 32 or tool is moved along respective paths corresponding to each object-powder interface 34A and 34B to ablate material and thereby form a groove 36 through layer 12 at each object-powder interface. The removal may be along the entirety of each object-powder interface, or along some portion thereof that may have certain smoothness requirements. The removal need not be along every object-powder interface. For example, if smoothness is critical to the inner cylindrical surface of object 10, but not to the outer cylindrical surface, then removal may be along inner object-powder interface 34A but not outer object-powder interface 34B. Conversely, if smoothness is critical to the outer cylindrical surface of object 10, but not to the inner cylindrical surface, then removal may be along outer object-powder interface 34B but not inner object-powder interface 34A.

The directed energy beam 32 may be a laser beam emitted by an ultrashort pulse laser, for example a femtosecond laser emitting pulses with durations between a few femtoseconds and hundreds of femtoseconds. Ultrashort pulses can provide clean ablation and may enable any metal or plastic condensate or vapor to be captured in the filters of the additive manufacturing machine. The parameters of energy beam 32 may be controlled so as to reduce heating to layers other than the one being operated upon. For example, the energy beam may have a specific spot size that is finer than that used for fusing the powder particles. In another example, this energy beam may have a shorter pulse than the beam used for fusing the powder particles. After the fusing laser operates, the melted material penetrates two or more layers deep so that the new layer is properly fused to the previous layer. Therefore, groove 36 formed by energy beam 32 may become partially filled with powder for a subsequent layer, and this new powder filling the groove may be partially or fully fused by the subsequent fusing operation, thus filling the groove. Therefore, it is desirable that energy beam 32 penetrate by at least one layer deeper than the newly fused layer to ensure that groove 36 remains clear of fused material.

FIG. 3 shows the formation of object 10 by an additive manufacturing method in accordance with a second embodiment of the present disclosure. The method of the second embodiment is similar to the method of the first embodiment, however the removed portion of the layer includes a peripheral skin portion 38 of the layer that extends deeper into object 10 than the corresponding object-powder interface 34A or 34B. Skin portion 38 includes the corresponding object-powder interface 34A or 34B, and also includes material where sub-surface defects 40 are commonly found. A groove 36 is formed through layer 12 to separate skin portion 38 from the remainder of layer 12. The depth of skin portion 38 is subject to choice depending on factors such as the expected depth of sub-surface defects 40. By way of non-limiting example, removing skin portion 38 to an internal depth of about 100 μm may be satisfactory. Depending upon dimensional tolerances established for object 10, a larger target area of fused material may be provided in layer 12 to compensate for the removed skin portion 38. The removed skin portion 38 may be further cut into smaller pieces to facilitate later removal with the rest of the powder particles. Cutting the skin portion 38 into smaller pieces may, for example, enable it to flow out of the additive manufacturing apparatus with the powder particles.

Reference is made now to FIG. 4 for describing how an object 10 is built layer-by-layer according to an embodiment of the present disclosure. In step 50, a powder level is added to powder bed 30. This may be an initial powder level, or a powder level added after formation of one or more layers 12. Those skilled in the art of additive manufacturing will understand that a level of powder may be applied using a spreader or wiper mechanism to cover a preceding object layer 12 with a uniform thickness of new powder. If a groove 36 or cavity is formed in the layer, then subsequent application or wiping of powder particles may fill in the cavity. Such filling may be compensated for so that the subsequent powder particles on top of the layer may be level, have the proper dimensions, or otherwise spread satisfactorily. For example, additional wipes or applications of powder particles may be performed or more powder particles may be added during the wipe or application.

In step 52, a target area of the powder bed is scanned with an energy beam to form a new layer 12 of fused powder. In step 54, a portion of the newly formed layer is removed either by the method of the first embodiment (shallow removal of the object-powder interface) or by the method of the second embodiment (deeper removal of skin). As described above, the removal is carried out while the object 10 is in powder bed 30. Once layer 12 is formed and a portion of the layer is removed, a decision block 56 is reached. If the object 10 is not yet completed, flow returns to step 50. The manufacturing steps are repeated sequentially to build object 10 layer-by-layer. Once object 10 is completed, it is removed from powder bed 30 in accordance with step 58.

In practicing the present disclosure, modifications are possible. For example, it is contemplated to switch between the first embodiment (shallow removal of the object-powder interface) and the second embodiment (deeper removal of skin) in treating a particular layer 12 or when proceeding from a formed layer to a new layer. The portion that is removed may vary depending on the expected presence of surface defects versus sub-surface defects, or based on other factors. As another example, the step of removing a portion of a newly fused layer may not be performed on all layers, but only on those layers that need to be substantially free of defects. It is also contemplated to carry out the removal step on multiple layers at one time.

The embodiments disclosed herein can be applied to many different industries. For example, dental devices, orthopedic devices, automotive parts, aerospace components, or cooling channels can benefit from the embodiments disclosed herein. Thus, additive manufacturing using an embodiment disclosed herein may be used to fabricate, for example, valve components, manifold components, seal components, electrical housing components, medical implants, or other objects. Objects that have smooth sliding surfaces, galleries, complex geometries, or that are used in applications where low FOD is desired may find particular benefits using the embodiments described herein.

Use of an embodiment disclosed herein can reduce or eliminate surface cleaning, polishing, blasting, machining or other additional process steps commonly used to remove surface or sub-surface defects after the object is removed from the powder bed of the additive manufacturing apparatus. Removal of surface or sub-surface defects in internal galleries or pockets that cannot typically be reached is possible. These embodiments also may enable additive manufacturing methods to be more commonly used for parts or applications that are sensitive to FOD. Fatigue properties of objects formed using additive manufacturing may be improved and overall cost of objects formed using additive manufacturing can be reduced. Thus, an embodiment disclosed herein can enable additive manufacturing, such as laser powder bed fusion technology, to be used more for applications where it was previously considered unsuitable.

While the method of the present disclosure increases the time spent building an object in the powder bed, the overall time and cost of manufacturing the object are decreased significantly because of savings realized in post-processing. The disclosure eliminates the need for defect removal and surface treatment operations performed after additive manufacturing, which may require additional tools, personnel, and/or transport of the product between facilities or stations. The method of the present disclosure removes a greater percentage of surface and sub-surface defects than known post-processing operations, and increases overall throughput.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method of additive manufacturing comprising the steps of:
forming a layer of an object in a powder bed by scanning a directed energy beam over a predetermined area of the powder bed to fuse powder in the predetermined area, wherein the layer defines an object-powder interface at a boundary where fused powder of the layer meets unfused powder of the powder bed; and
removing a portion of the layer while the object is in the powder bed.

2. The method of claim 1, wherein the removed portion of the layer includes only the object-powder interface.

3. The method of claim 1, wherein the removed portion of the layer includes a skin portion of the layer deeper than the object-powder interface.

4. The method of claim 1, wherein the step of removing the portion of the layer is performed using the directed energy beam used to form the layer.

5. The method according to claim 4, wherein the directed energy beam is a laser beam.

6. The method according to claim 4, wherein the directed energy beam is an electron beam.

7. The method of claim 1, wherein the step of removing the portion of the layer is performed using a second directed energy beam different from the directed energy beam used to form the layer.

8. The method according to claim 7, wherein the second directed energy beam is a laser beam.

9. The method according to claim 7, wherein the second directed energy beam is an electron beam.

10. The method of claim 1, wherein the step of removing the portion of the layer is performed using a high-speed tool.

11. The method of claim 1, further comprising the step of applying a level of powder to the powder bed.

12. The method of claim 11, wherein the steps of applying the level of powder, forming the layer of the object, and removing the portion of the layer are repeated sequentially to build the object layer-by-layer.
